(19) United States
(12) Patent Application Publication
(10) Pub. No.: US 2006/0085472 A1
(43) Pub. Date: Apr. 20, 2006

(54) Device administrative system and administrative server

(75) Inventor: Mitsuhiro Nakamura, Ibaraki-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Konica Minolta Business Technologies, Inc., Tokyo (JP)

(21) Appl. No.: 11/011,088

(22) Filed: Dec. 15, 2004

(30) Foreign Application Priority Data
Sep. 24, 2004 (JP) 2004-277804

(51) Int. Cl. G06F 7/00

(52) U.S. Cl. 707/102

(57) ABSTRACT

A device administrative system includes a plurality of devices-to-be-administrated, at least one collecting server, an administrative server storing administrative information of the plurality of devices-to-be-administrated, and a user terminal for browsing the administrative information stored in the administrative server. A communication route for transmitting the administrative information between each of the plurality of devices-to-be-administrated and the administrative server directly or via the at least one collecting server is determined in advance. A storing portion for storing display information on a logical connection structure is provided so that the plurality of devices-to-be-administrated and/or the at least one collecting server can be displayed in a previously determined hierarchical or grouped manner regardless of the communication route when the user terminal browses the administrative information.

This application claims priority under 35 U.S.C. § 119 to Japanese Patent Application No. 2004-277804 filed on Sep. 24, 2004, the entire disclosure of which is incorporated herein by reference in its entireties.

### BACKGROUND OF THE INVENTION

1. Field of the Invention

The present invention relates to a device administrative system for administering a device-to-be-administered, such as an image forming device, and also relates to an administrative server to be used in such administrative system.

2. Description of the Related Art

The following description sets forth the inventor's knowledge of related art and problems therein and should not be construed as an admission of knowledge in the prior art.

In companies, etc., having a hierarchical organization including, e.g., a head office, branches, subbranches and service branches, it has been conventionally performed that one or a plurality of devices-to-be-administered belonging to each department that performs the maintenance thereof are administrated by an administrative server to thereby integrally administrate all of the devices-to-be-administered.

As an example of such administrative system for integrally administering a plurality of devices-to-be-administered existing hierarchically, Japanese Unexamined Laid-open Patent Publication No. H11-353145 proposes a two-layered type administrative system in which administrative information collected by a first collecting server is transmitted to a second collecting server on a network and a method for providing the administrative information.

In conventional administrative systems, however, the collecting routes for collecting administrative information by an administrative server are hierarchical, in other words, the physical connection status of devices-to-be-administered is also hierarchical. Therefore, when a communication failure occurs between the administrative server and a device-to-be-administered, it was difficult to collect administrative information of the device-to-be-administered positioned lower than the failure portion.

Furthermore, in cases where a hierarchical relation in an organization is changed or a new department for administering devices-to-be-administered is added, it is required to change the existing collecting routes and/or add a new route for collecting administrative information. This requires troublesome operations, deteriorating the system operation efficiency.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The preferred embodiments of the present invention can significantly improve upon existing methods and/or apparatuses.

Among other potential advantages, some embodiments can provide a device administrative system capable of preventing an occurrence of difficulty in collecting administrative information of a device-to-be-administered positioned lower than a failure portion even if a communication failure occurs between the administrative server and the device-to-be-administered.

Among other potential advantages, some embodiments can provide a device administrative system that does not necessitate a change or an addition of a collecting route of administrative information even if a change of organization and/or an addition of department which administrates a device-to-be-administered occurs.

Among other potential advantages, some embodiments can provide an administrative server for use in the aforementioned device administrative system.

According to a first aspect of the preferred embodiment of the present invention, a device administrative system, comprising:
a plurality of devices-to-be-administrated;
at least one collecting server;
an administrative server storing administrative information of the plurality of devices-to-be-administrated; and
a user terminal for browsing the administrative information stored in the administrative server,
wherein a communication route for transmitting the administrative information between each of the plurality of devices-to-be-administrated and the administrative server directly or via the at least one collecting server is determined in advance, and
wherein a storing portion for storing display information on a logical connection structure is provided so that the plurality of devices-to-be-administrated and/or the at least one collecting server can be displayed in a previously determined hierarchical or grouped manner regardless of the communication route when the user terminal browses the administrative information.

According to a second aspect of the preferred embodiment of the present invention, an administrative server that stores administrative information of a plurality of devices-to-be-administrated and transmits the administrative information to a user terminal, the administrative server, comprising:
a storing portion for storing display information on a logical connection structure so that a plurality of devices-to-be-administrated and/or at least one collecting server can be displayed in a previously determined hierarchical or grouped manner regardless of a communication route which communicates the administrative information directly or via the at least one collecting server between the administrative server and each of the plurality of devices-to-be-administered when a user terminal browses the administrative information; and
a transmitting portion for transmitting information for displaying the plurality of devices-to-be-administered and/or the at least one collecting server in a previously determined hierarchical or grouped manner to the user terminal based on the display information stored in the storing portion.

According to a third aspect of the preferred embodiment of the present invention, a device administrative system, comprising:
a user terminal,
a plurality of devices-to-be-administrated, and
a plurality of collecting servers that collect administrative information from at least one of the plurality of devices-to-be-administrated,
wherein one of the plurality of collecting servers functions as an administrative server, which is accessible from the user terminal, the administrative server comprises:
an administrative information storing portion for storing the administrative information of the plurality of devices-to-be-administrated collected from other colleting servers,
a display image creating portion for creating a display image in a logical connection structure showing a hierarchical relation of the collecting servers corresponding to a hierarchical organization, and
a transmitting portion for transmitting the display image created by the display image creating portion and the administrative information stored in the administrative information storing portion.

According to a fourth aspect of the preferred embodiment of the present invention, an administrative server, comprising:
a communication portion which obtains administrative information from devices-to-be-administrated via a collecting server according to actual connection;
an administrative information storing portion for storing administrative information of the devices-to-be-administered obtained by the communication portion;
a display image creating portion for creating a display image on a logical connection structure showing a hierarchical relation of the collecting servers corresponding to the hierarchical organization; and
a transmitting portion for transmitting the created display information and the administrative information stored in the administrative information storing portion to a accessed user.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is an explanatory view showing a hierarchical relation of collecting servers in an administrative system according to an embodiment of the present invention;

FIG. 2 is an explanatory view showing a physical connection status of the collecting servers;

FIG. 3 is an explanatory view showing a browsing system to be used by a user to browse administrative information administered by the administrative system;

FIG. 4 is a block diagram showing the schematic structure of the administrative server;

FIG. 5 shows server information;

FIGS. 6A to 6C are transitional screen views showing the change of collecting server logical connection structure displayed on a display screen of an web page by a GUI;

FIG. 7A and 7B are explanatory views showing the change of collecting server logical connection structure;

FIG. 8 is a flowchart showing the head office processing for changing collecting server logical connection structure;

FIG. 9 is a flowchart showing a procedure for collecting administrative information of devices-to-be-administered from a head office server as an administrative server in accordance with operations of an administrator, etc.;

FIG. 10 is a flowchart showing a procedure for automatically collecting error information of an image forming device as a device-to-be-administered from a headquarters' server;

FIG. 11 is a flowchart showing contents of error notification processing at S31 shown in FIG. 10;

FIG. 12 is a flowchart showing processing performed when a user accesses administrative information in the database through a web page;

FIG. 13 is a flowchart showing contents of database authentication processing at S43 shown in FIG. 12; and

FIG. 14 is a flowchart showing contents of database extraction processing at S50 shown in FIG. 12.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

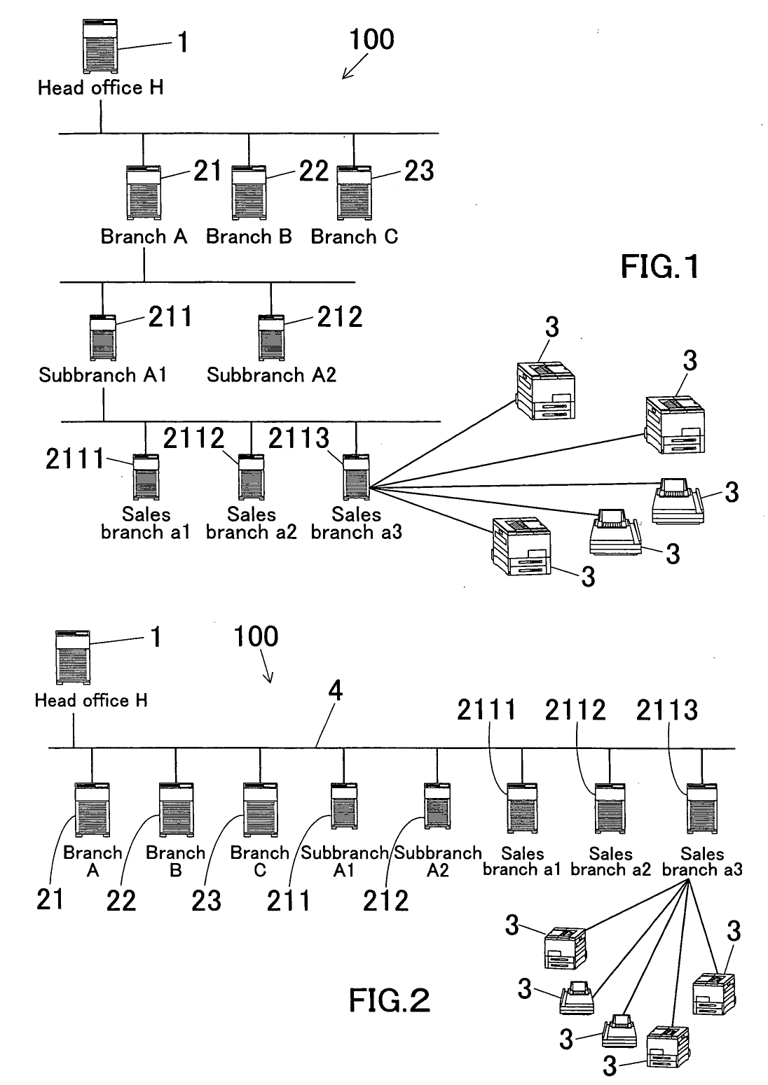

FIG. 1 is an explanatory view showing a hierarchical relation of collecting servers in an administrative system according to an embodiment of the present invention, and FIG. 2 is an explanatory view showing a physical connection status of the collecting servers. In this embodiment, image forming apparatuses, such as printers, copying machines and facsimile machines, are exemplified as devices-to-be-administered.

As shown in FIG. 1, this administrative system 100 is used in a four layered hierarchical organization of a company or the like having a head office H, branches A to C belonging to the head office H, subbranches A1 and A2 belonging to the branch A and sales branches a1 to a3 belonging to the subbranch A1. This system 100 is provided with a collecting server (hereinafter referred to as “head office server”) 1 installed in the head office H, collecting servers 21 to 23 installed in the branches A to C respectively, collecting servers 211 and 212 installed in the subbranches A1 and A2 respectively, and collecting servers 2111 to 2113 installed in the sales branches a1 to a3 respectively. Each server is defined as an upper level server or a lower level server depending on the level in the four layered hierarchical organization.

Concretely, the head office server 1 is defined as an uppermost level collecting server. In this embodiment, the head office server 1 is set as an administrative server. As the lower level servers of the head office server 1, collecting servers 21 to 23 belonging to the branches A to C respectively exist. Furthermore, as the lower level servers of the collecting server 21 belonging to the branch A, collecting servers 211 and 212 belonging to the subbranches A1 and A2 respectively exist. And furthermore, as the lower lever servers of the collecting server 211 belonging the subbranch A1, collecting servers 2111 to 2113 belonging to the sales branches a1 to a3 respectively exist.

To the administrative server 1 and each collecting server 21 to 2113, one or a plurality of devices-to-be-administered (e.g., image forming devices) administered by respective servers are connected in a communicable manner, as shown in FIG. 1 which representatively illustrates the connecting status of the collecting server 2113 belonging to the sales branch a3. Each server stores the administrative information of each device-to-be-administered in each database and administers the information. Such information includes, for example, count information which is the number of times image forming operation was performed, the number of times a certain component (e.g., fixing rollers) was used, the status of use of material such as toner, the type, occurred data and time and cumulative number of errors, and various setting conditions of devices-to-be-administered (e.g., transferring voltage or conditions of developing bias). The aforementioned system may include some collecting servers to which no device-to-be-administered 3 is connected.

On the other hand, as shown in FIG. 2, the head office 1 as an administrative server is directly connected to the other collecting servers 21, 22 . . . via a network 4 so that the head office server 1 directly obtains administrative information of each device-to-be-administered 3 by directly communicating with collecting servers 21 . . . ,

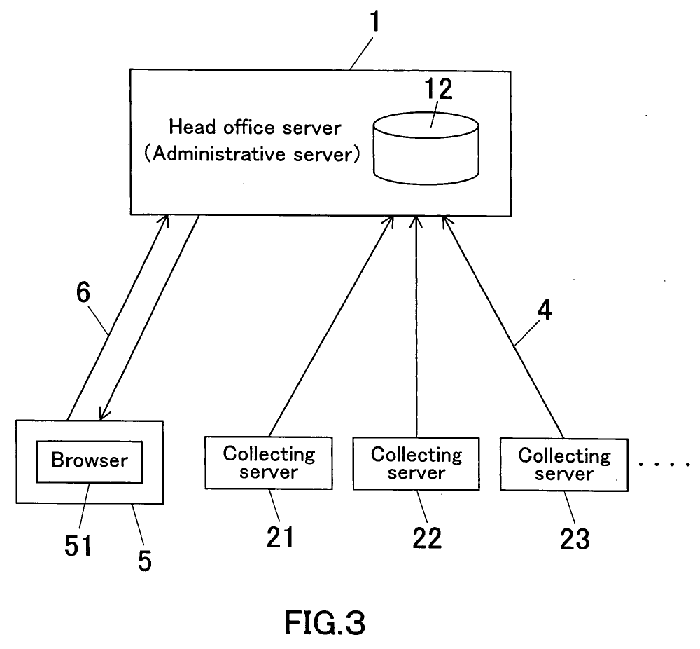

FIG. 3 is an explanatory view showing a browsing system to be used by a user who is a member of the company to browse administrative information administered by the administrative system.

The head office server 1 is provided with a web server function so that a user can browse the administrative information, which was directly collected from each collecting server 21, 22 . . . and stored in the database 12 of the head office server 1, on the web page with a browser 51 by accessing the head office server 1 via a network 6 from a user terminal 5.

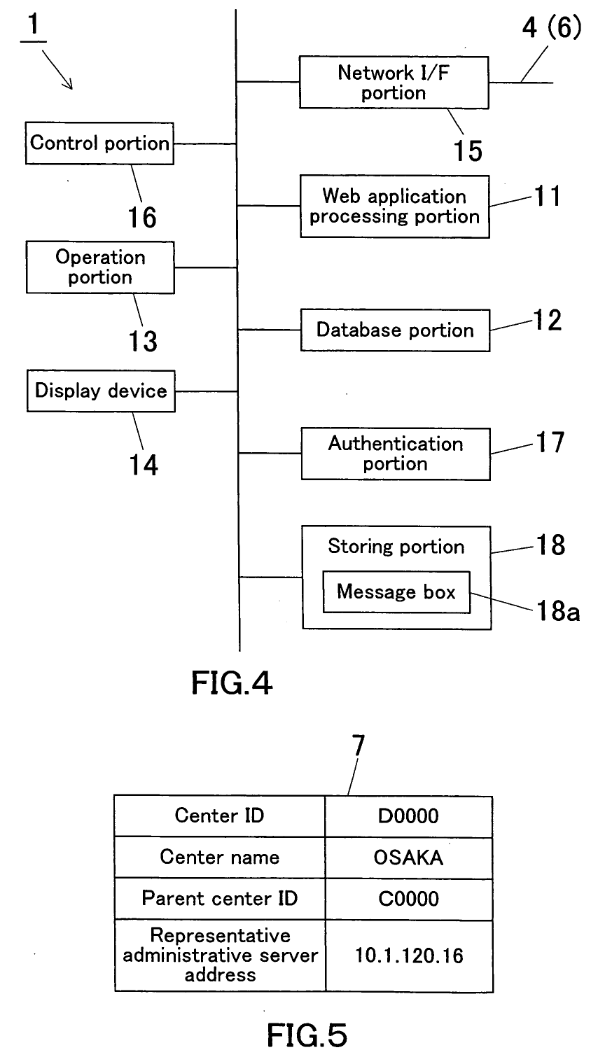

FIG. 4 is a block diagram showing a schematic structure of the head office server 1.

This head office server 1 is provided with a web application processing portion 11, a database portion 12, an operation portion 13, a display device 14, a network interface portion (“network I/F portion” in FIG. 4) 15, a control portion 16, an authentication portion 17 and a storing portion 18.

The web application processing portion 11 executes processing for creating a web page including a display image of the logical connection information of the administrative server 1, collecting servers 21, 22 . . . , so that a user accessed the head office server 1 via the network 6 can browse the web page created by the web application processing portion 11 as explained above.

The database portion 12 accumulates administrative information regarding the device-to-be-administered 3 collected from each collecting server, stores the server information of each collecting server, user information and various passwords, and further stores restriction information and the like for restricting browsing of the administrative information by users and/or operations to the administrative server depending on users, and various data. Role settings defining, e.g., browsing authority and operation authority to the administrative server in advance, are given to each user, and the role information showing the contents of the role settings is stored in the database portion 12. Based on the role settings contained in the role information, browsing of the administrative information and/or operations against the administrative server by a user is restricted when the user accesses the administrative server.

FIG. 5 shows a table of the server information 7. The server information 7 includes a center ID showing an ID code of the administrative server, the center name showing the name of the collecting server, a parent center ID showing an ID code of the server (parent server) positioned immediately above the administrative server in the organization, and an IP address of the administrative server.

The web application processing portion 11 creates a display image for displaying the logical connection structure showing the hierarchical relation of each server 1, 21, . . . , based on the parent center ID, which is the display information among the server information 7. The logical connection structure will be detailed later.

The operation portion 13 is provided with, e.g., a keyboard and a mouse, and is operated by an administrator of the head office server 1. The display device 14 displays, e.g., various data and documents.

The network interface portion 15 functions as a communication portion for directly communicating with other collecting servers 21, 22, . . . , and also functions as a transmission portion for transmitting the web page created by the web application processing portion 11 to the user terminal 5 accessed the head office server 1.

The control portion 16 controls the entire head office server 1. For example, when the head office server 1 is instructed by a user to obtain the administrative information on a certain device-to-be-administered that a certain collecting server administers, the control portion 16 controls the network interface portion 15 to initiate data communication between the collecting server and the device-to-be-administered. Furthermore, when the head office server 1 is accessed by a user to browse the web page, the control portion 16 controls the web application processing portion 11 so as to make the web application processing portion 11 create the web page with a browsing restriction depending on the user and output it to the user terminal 5.

The authentication portion 17 executes authentication of a user accessed the head office server 1 based on the user information, etc., stored in the database portion 12.

The storing portion 18 stores, e.g., various IDs, user names, passwords inputted by users, and also stores various information read out of the database portion 12. This storing portion 18 is provided with a message box 18a for storing messages transmitted from collecting servers.

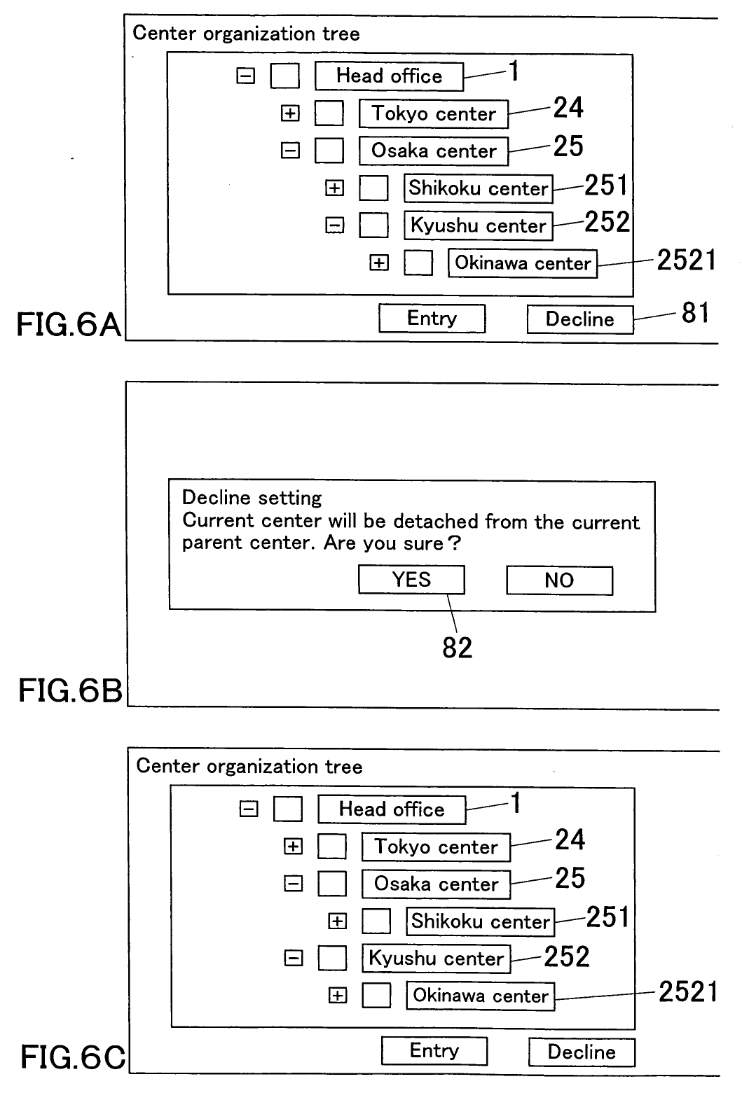

FIG. 6A illustrates an entire logical connection structure of the administrative server and collecting servers displayed on the display screen of a web page with a GUI (graphical user interface). In FIG. 6A, the administrative server and collecting servers are displayed in a hierarchical or grouped manner. This display screen can be freely browsed by a user (including an administrator), so that a user can, in one glance, recognize the hierarchical relation or group relation of the entire server organization.

In the embodiment shown in FIG. 6A, the display screen shows the connection structure in which Tokyo center collecting server (hereinafter may be referred to as “Tokyo center server” or “Tokyo center”) 24 and Osaka center collecting server (hereinafter may be referred to as “Osaka center server” or “Osaka center”) 25 are positioned under the head office server (hereinafter may be referred to as “head office”) 1, Shikoku center collecting server (hereinafter may be referred to as “Shikoku center server” or “Shikoku center”) 251 and Kyushu center collecting server (hereinafter may be referred to as “Kyushu center server” or “Kyushu center”) 252 are positioned under Osaka center server 25, and Okinawa center collecting server (hereinafter may be referred to as “Okinawa center server” or “Okinawa center”) 2521 is positioned under Kyushu center server 252.

The creation of the display image showing such a logical connection structure and the display by a GUI are performed by the web application processing portion 11 based on the contents of the parent center ID as display information of the server information 7 stored in the database portion 12 of the head office server 1.

Now, an operation for changing the logical connection structure of the entire server shown in FIG. 6A to be performed by the administrator or the like of the head office server 1 based on organization changes and the like will be explained. In this example, the following explanation will be directed to the case in which Kyushu center server 252 positioned under the administration of Osaka center server 25 is changed so as to be positioned under the administration of the head office server 1.

Initially, among the GUI shown in FIG. 6A, “Kyushu center server” 252 is selected by clicking on it, which in turn causes the selected “Kyushu center” to be displayed inverted (not shown). In this state, when the “Decline” button 81 is selected by clicking on it, the screen shown in FIG. 6A will be changed into the confirmation screen of FIG. 6B indicating that the selected Kyushu center 252 will be detached from the current parent server (Osaka center server).

The selection of the “Yes” button 82 causes screen changes from the confirmation screen to a password input screen (not shown). When a password is inputted on the password input screen, the contents of the parent center ID in the server information 7 of Kyushu center will be rewritten from the ID of Osaka center server 25 to the ID of head office server 1 which is a parent server of Osaka center server 25. Then, the screen will be changed into a screen shown in FIG. 6C in which “Kyushu center” is detached from “Osaka center” and positioned under the administration of the head office server 1.

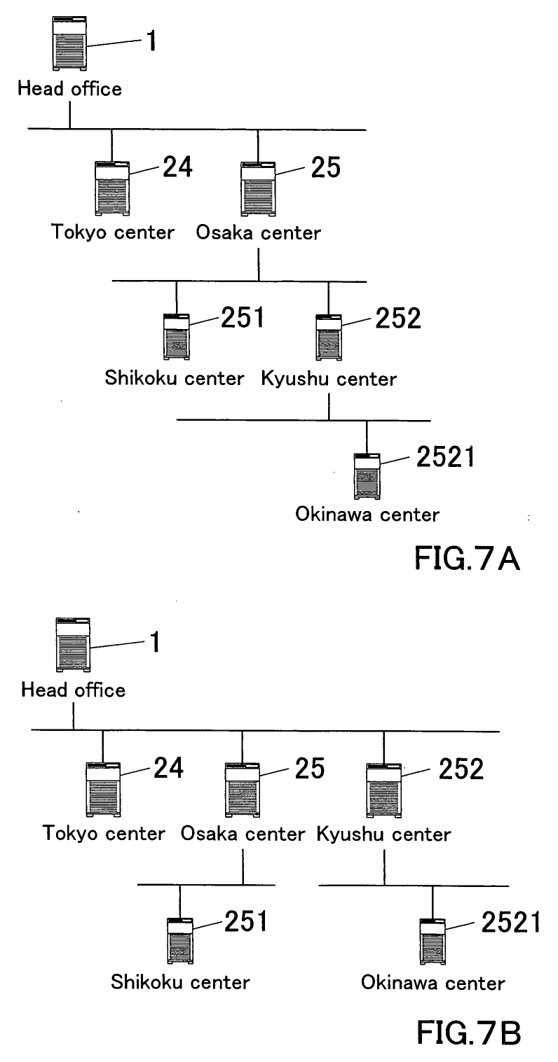

In detail, as shown in FIG. 7A, in the logical connection structure before the change, Tokyo center server 24 and Osaka center server 25 were positioned under the administration of the head office server 1, Shikoku center server 251 and Kyushu center server 252 were positioned under the administration of Osaka center server 25, and Okinawa center server 2521 was positioned under the administration of Kyushu center server 252. However, after the change, as shown in FIG. 7B, Osaka center server 25, Tokyo center server 24 and Kyushu center server 252 are positioned under the administration of the head office server 1. In other words, Kyushu center server 252 is released from the administration of the Osaka censer server 25 and now positioned under the administration of the head office server 1.

As will be understood from the above explanation, by simply specifying a server to be changed on a screen, the parent center ID of the server information will be changed, which in turn changes the display of the logical connection structure. Therefore, it becomes possible to easily cope with the changes of logical connection structure of the administrative server in accordance with the organization changes, addition and/or deletion of new departments, etc. Furthermore, in the actual connection between the administrative server and each collecting server, as already shown in FIG. 2, since the collecting servers are connected to the administrative server 1 not in a hierarchical manner but in a direct manner, no change of the actual connection relation will be required regardless of the organization structure change. In other words, regardless of the communication route (actual connection) for transmitting administrative information, the logical connection structure can be easily changed.

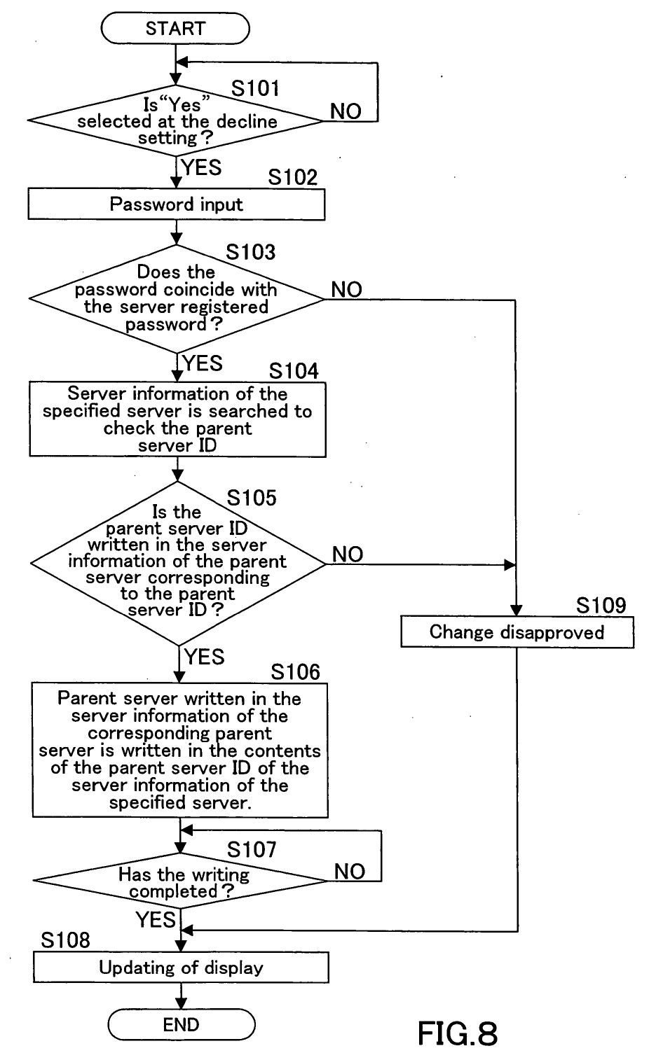

FIG. 8 is a flowchart showing the processing of the head office server 1 for changing the server's logical connection structure as shown in FIGS. 6 and 7.

After selecting a collecting server to be changed displayed by GUI on the screen shown in FIG. 6A, the administrator or the like selects the “Yes” button shown in FIG. 6B. At S101, the control portion 16 waits for the selection of the “Yes” button. When the “Yes” button is selected (“Yes” at S101), at S102, a password of the specified server (“Kyushu center server” in the example shown in FIGS. 6 and 7) inputted on the password input screen is received, and then the routine proceeds to S103.

At S103, the control portion 16 discriminates whether the inputted password coincides with the password of the specified server registered in the database portion 12. If it is discriminated that it coincides with the password (“Yes” at S103), at S104, the control portion 16 conducts a search for the server information of the specified server stored in the database portion 12 to check the contents of the parent server ID.

Subsequently, at S105, it is discriminated whether a parent server ID is written in the server information of the parent server (Osaka center server in the example shown in FIGS. 6 and 7) corresponding to the parent server ID. If it is written (“Yes” at S105), at S106, the parent server ID will be written in the contents of the parent server ID of the server information of the specified server, and the routine waits for the completion of the writing at S107. After the completion of the writing (“Yes” at S107), at S108, the control portion 16 makes the web application processing portion 11 update the display of the logical connection structure into a display of the changed logical connection structure. Then, the processing terminates.

If the inputted password does not coincide with the registered password at S103 (“No” at S103) or if no parent server ID is written in the server information of the parent server (“No” at S105), it is discriminated, at S109, that no logical connection structure change can be made. In this case, the display of the logical connection structure remains unchanged.

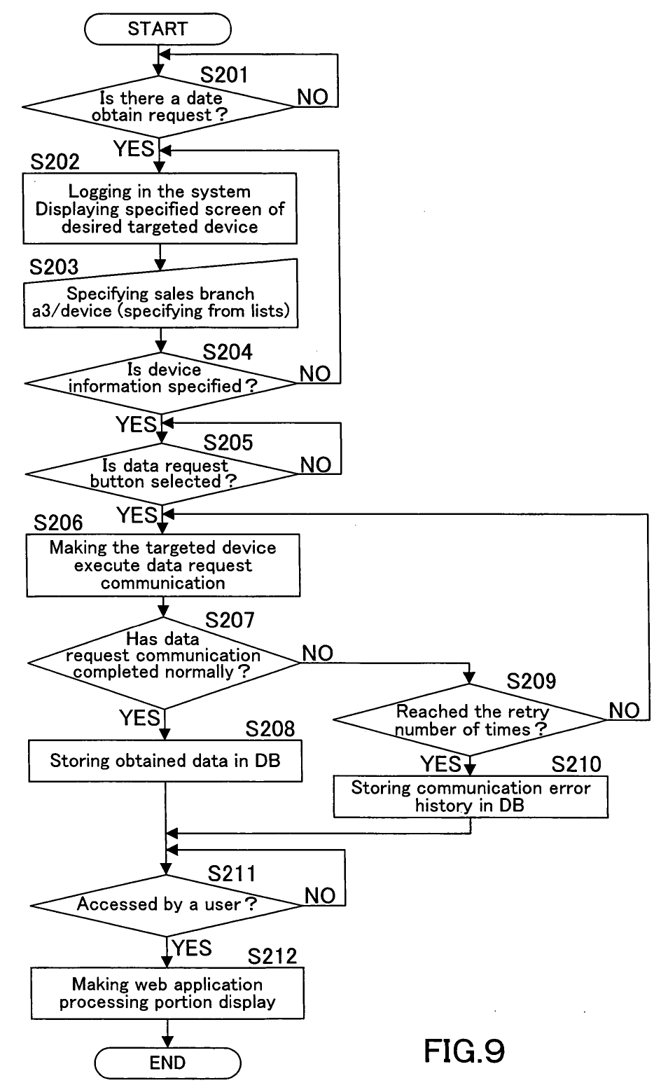

FIG. 9 shows a flowchart showing a procedure for collecting administrative information of a prescribed device-to-be-administered 3 from the head office server 1 as an administrative server in accordance with an operation by an administrator or the like in the administrative system shown in FIGS. 1 and 2.

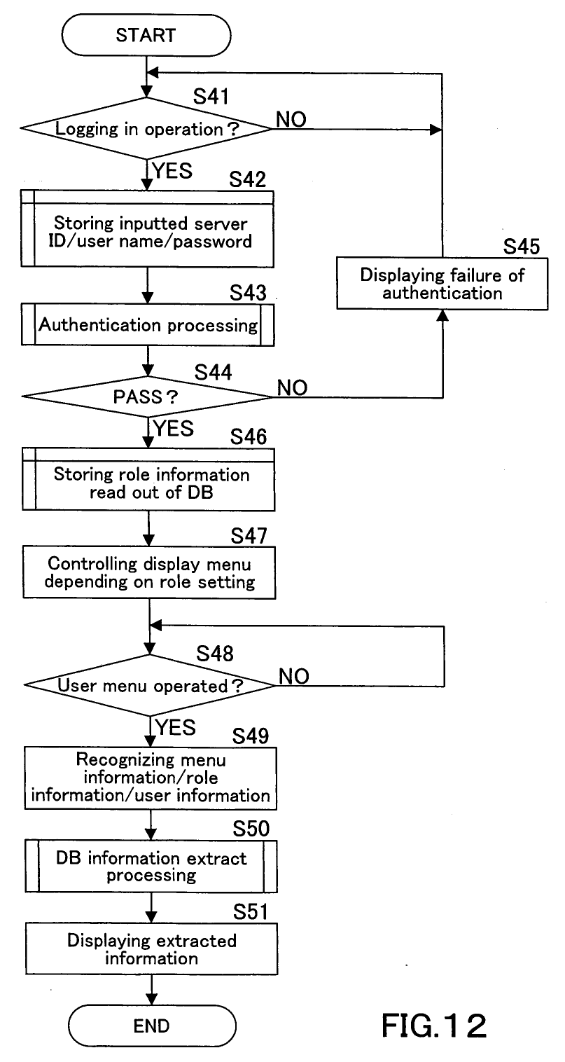

At S201, in cases where a user wishes to perform a data obtaining request against a user's device-to-be-administered 3 (“Yes” at S201), at S202, the user executes login procedures to the administrative system. Then, the user makes the web application processing portion 11 display a specified screen of a prescribed device-to-be-executed 3 from which the user intends to obtain information (since an accessible device is discriminated based on the login information, a specific device can be specified. Processing shown in FIG. 12).

If a user specifies, for example, a device-to-be-administered 3 which is being administered in a sales branch a3 (S203), at S204, it is discriminated whether a device is specified. If specified (“Yes” at S204), the routine proceeds to S205. If no device is specified (“No” at S204), the routine returns to S202.

At S205, the routine waits for the data request button to be selected. When the button is selected (“Yes” at S205), at S206, a data request communication for obtaining administrative information from the specified device-to-be-administered is executed via the network interface portion 15.

At S207, it is discriminated whether the data request communication was completed normally. If completed normally (“Yes” at S207), at S208, the obtained administrative information is stored in the database portion (shown as “DB” in FIG. 9) 12, and then the routine proceeds to S211. If not completed normally (“No” at S207), the data request communication and normality completion discrimination at S207 will be repeated until they reach a retry number of times at S209.

When they reach the retry number of times (“Yes” at S209), at S210, the communication error history is stored in the database portion 12, and then the routine proceeds to S211.

At S211, the routine waits for an access for browsing administrative information from a user terminal 5. If it is discriminated that there is an access (“Yes” at S211), at S212, the control portion 16 makes the web application processing portion 11 create a web page showing the contents to be browsed and also makes the user terminal 5 display it, and then terminates the processing.

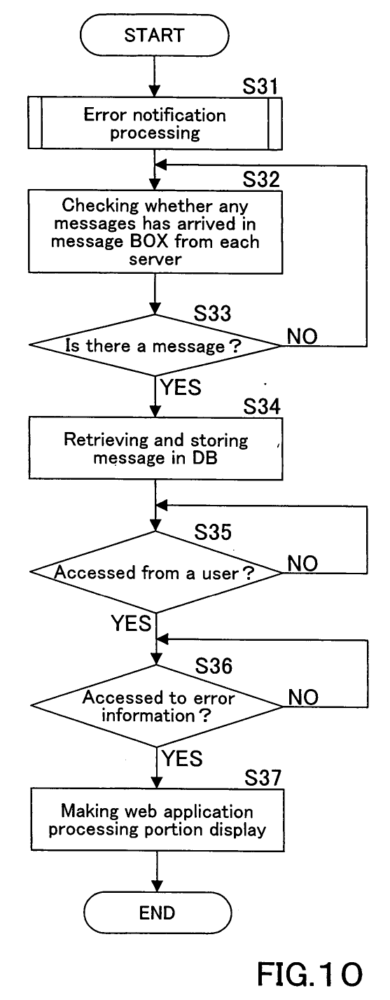

FIG. 10 is a flowchart showing the procedures for automatically collecting error information of the device-to-be-administrated 3 from the head office server 1 as an administrative server.

At S31, error notification processing is performed. This error notification processing will be detailed later.

Next, at S32, the control portion 16 checks whether any messages from each collecting server have been arrived in a message box 18a, and then at S33 discriminates whether there is any messages.

If there is no message (“No” at S33), the routine returns to S32 to repeat the procedures of S32 and S33. If there is a message (“Yes” at S33), at S34, the messages are stored in the database portion 12.

Then, at S35, the routine waits for an access from a user terminal 5. If there is an access (“Yes” at S35), at S36, the routine waits for an access to the error information. If there is an access (“Yes” at S36), at S37, the control portion 16 makes the web application processing portion 11 create a web page showing the contents of error information, and makes the user terminal 5 transmit and display it. Then, the processing terminates.

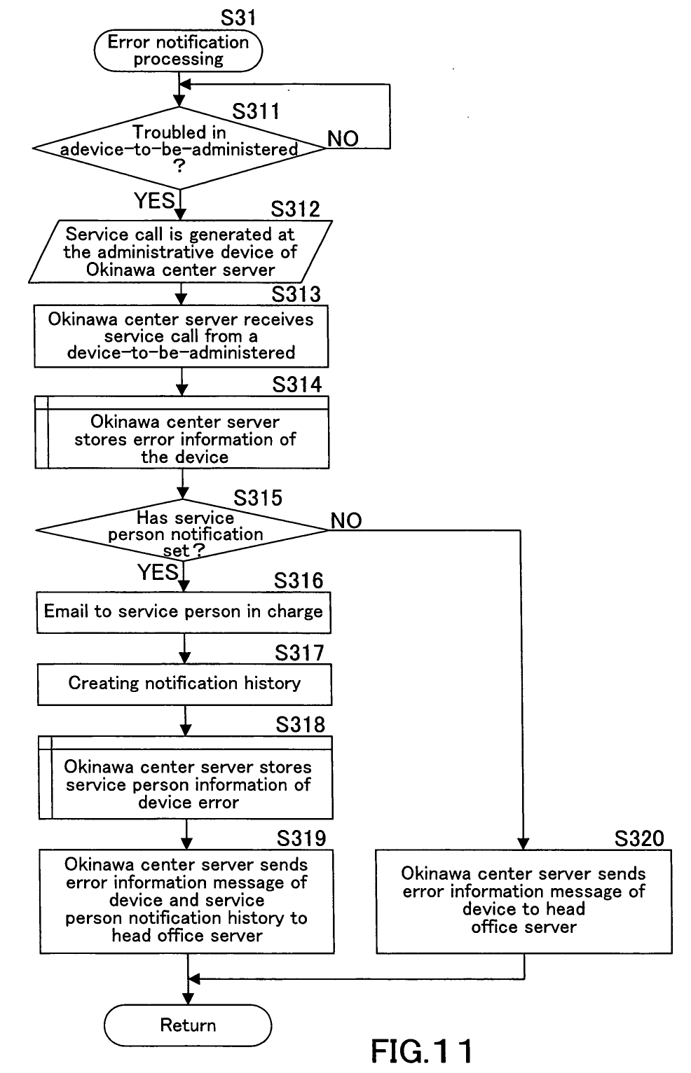

FIG. 11 is a flowchart showing the contents of error notification processing at S31 shown in FIG. 10.

At S311, each administrative server 1, 21, 22 . . . waits for an occurrence of any troubles of a device-to-be-administered which is being administered. If a trouble occurs (“Yes” at S311) and, for example, a service call occurs at the device-to-be-administered of Okinawa center server 2521 (S312), at S313, Okinawa center server 2521 receives the service call from the device-to-be-administered.

Then, at S314, Okinawa center server 2521 stores the error information of the device-to-be-administered 3, and then, at S315, Okinawa center server 2521 discriminates whether a notification setting to a service person has been made. If a service person notification setting has been made, (“Yes” at S315), at S316, the occurrence of trouble is emailed to a service person in charge. Thereafter, at S317, a notification history is created, and at S318, the service person notification history information on the device error is stored. At S319, Okinawa center server 2521 notifies the head office server 1 of the error information and the service person notification history, and then the routine returns. The message notified to the head office server 1 is stored in the message box 18a of the head office server 1.

On the other hand, at S320, if no notification setting to a service person has been set (“No” at S315), at S320, Okinawa center server 2521 notifies the head office server of only the error information of the device 3.

As mentioned above, when an error occurs in any device-to-be-administered, the error information and the service person notification history information are notified to the head office server 1. Thus, the user can recognize that an error occurred in a device-to-be-administered 3 of a collecting server via a web page.

Furthermore, in cases where a collecting server itself goes wrong, an user can recognize the trouble as follows. That is, the head office server 1 circularly communicates with each collecting server 21, 22, . . . Under the circumstance, in cases where one of the collecting servers is out of order, the control portion 16 of the head office server 1 marks the administrative server as a warning state since no normal response can be obtained from the collecting server.

If a normal response cannot be obtained from the server at the time of the next cyclic communication, the head office server 1 recognizes that the collecting server is abnormal. The head office server 1 holds the recognition of abnormality until a normal communication with the collecting server becomes available at the time of cyclic communication.

In the warning state, the control portion 16 of the head office server 1 makes the web application processing portion 11 set a warning display showing the occurrence of abnormalities of the collecting server on the logical connection structure displayed by GUI on the web page. Examples of such warning display include changing of the display color of the collecting server and showing a specific mark or message. The warning display remains until a normal communication with the collecting server becomes available at the time of cyclic communication. Furthermore, when it becomes a warning state, the control portion 16 of the head office server 1 automatically gives notice to a person in charge of the collecting server in which an error occurred via, e.g., e-mail or telephone.

FIG. 12 is a flowchart showing procedures at the head office server 1 in cases where a user accesses the administrative information in the database 12 by specifying a collecting server on a web page.

At S41, the control portion 16 of the head office server 1 waits for a login operation by a user. If a login operation is made (“Yes” at S41), at S42, the inputted administrative server ID, user name and password are stored in the storing portion 16.

Thereafter, the control portion 16 makes the authentication portion 17 execute authentication processing at S43. This processing will be detailed later.

When the authentication is approved (“Yes” at S44), the routine proceeds to S46. To the contrary, if the authentication is not approved (“No” at S44), at S45, the control portion 16 makes the web application processing portion 11 display the failure of authentication on the user terminal 5 and waits for the next login operation by the user.

At S46, the control portion 16 makes the storing portion 16 store the aforementioned role information read out of the database portion 12, and then makes the web application processing portion 11 create a display menu in accordance with the role setting.

Next, at S48, the routine waits for a menu operation by a user. When a menu operation is made (“Yes” at S48), at S49, the control portion 16 recognizes the menu information, role information and user information. After executing database information extract processing at S50, the control portion 16 makes the user terminal 5 display the extracted information via the web application processing portion 11. The database extract processing at S50 will be detailed later.

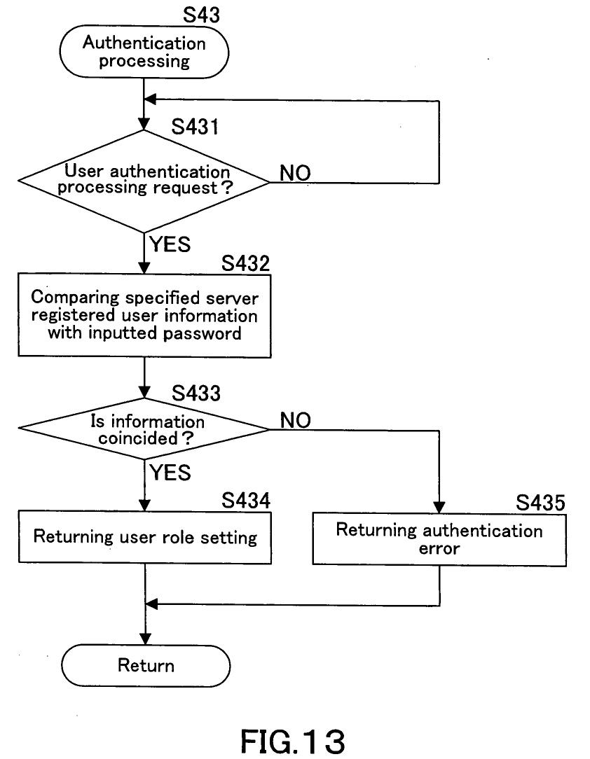

FIG. 13 is a flowchart showing the contents of authentication processing performed at S43.

At S431, the routine waits for an authentication processing request from a user. If an authentication processing request is made (“Yes” at S431), at S432, the authentication portion 17 compares the registered user information and password of the specified collecting server and the input information by a user.

Then, at S433, it is discriminated whether the registered information coincides with the inputted information. If the registered information coincides with the inputted information (“Yes” at S433), at S434, the role setting of the user will be returned. If the registered information does not coincide with the inputted information (“No” at S433), at S435, the authentication error is returned. Then, the routine returns.

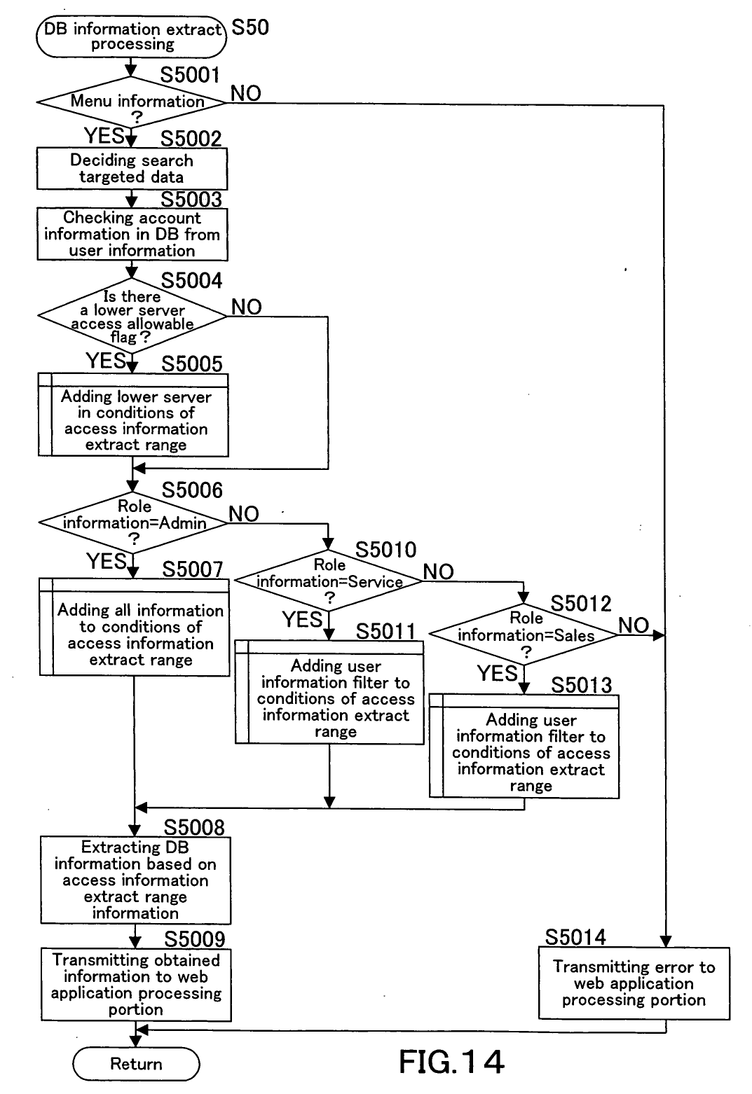

FIG. 14 is a flowchart showing the contents of the database information extract processing performed at S50 shown in FIG. 12.

At S5001, the control portion 16 checks whether menu information exists. If no menu information exists (“No” at S5001), an error is transmitted to the web application processing portion 11 at S5014, and then the routine returns.

If menu information is transmitted (“Yes” at S5001), at S5002, data to be searched is determined from the menu information. At S5003, account information in the database 12 is checked based on the user information, and then at S5004 it is checked by a flag whether the user is authorized to access to a lower collecting server. If the user is authorized to access to a lower collecting server (“Yes” at S5004), at S5005, the lower collecting server is added to the conditions of the access information extract range, and then the routine proceeds to S5006. To the contrary, if the user is not authorized to access to a lower collecting server (“No” at S5004), the routine proceeds to S5006 as it is.

At S5006, it is discriminated whether the role information is an administrator. If the role information is an administrator (“Yes” at S5006), at S5007, all of the information is added to the conditions of the access information extract range. Then, the routine proceeds to S5008.

At S5006, if the role information is not an administrator (“No” at S5006), at S5010, it is discriminated whether the role information is a service person. If the role information is a service person (“Yes” at S5010), at S5011, a user information filter for restricting a service person to browse information is added to the conditions of the access information extract range, and then the routine proceeds to S5008.

At S5010, if the role information is not a service person (“No” at S5010), at S5012, it is discriminated whether the role information is a sales person. If the role information is a sales person (“Yes” at S5012), at S5013, a user information filter for restricting a sales person to browse information is added to the conditions of the access information extract range, and then the routine proceeds to S5008. At S5012, if the role information is not a sales person (“No” at S5012), at S5014, the error is transmitted to the web application processing portion 11. Then, the routine returns.

At S5008, database information (administrative information) is extracted based on the access information extract range information. Subsequently, at S5009, the extracted database information is transmitted to the web application processing portion, and then the routine returns.

As will be apparent from the above, if the role information is an administrator, the administrator can browse all of the information. If the role information is a service person or a sales person, the information can be browsed within the respective limited ranges. The displayable range (device information administered by the belonged branch, subbranch or sales branch) can be restricted such that the displayable range differs depending on the position of the administrator, service person, sales person (sales branch, branch or subbranch).

Although an embodiment of the present invention is explained above, the present invention is not limited to the above embodiment. For example, in the above embodiment, the head office server 1 is set to an administrative server. However, an administrative server is not limited to a head office server but can be any one of collecting servers including the head office server.

Furthermore, in the above explanation, the administrative server is equipped with a web server function by providing the web application processing portion 11. However, it can be configured such that the web application processing portion 11 of the administrative server is replaced with an external web server in the administrative server.

Furthermore, although a user authentication is performed in the administrative server in the above embodiment, the user authentication can be performed at an outside authentication server.

In the above embodiment, an image forming device is exemplified as a device-to-be-administrated. However, the device-to-be-administrated can be any home appliances or another device.

Although the administrative information of device-to-be-administered is transmitted to the administrative server via collecting servers in the aforementioned embodiment, such collecting server is not always necessary, and an administrative server can be directly connected to a device-to-be-administered. In this case too, the devices-to-be-administrated can be displayed in a hierarchic or grouped manner depending on the form of organization.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example;” and “NB” which means “note well.”

What is claimed is:

1. A device administrative system, comprising:
a plurality of devices-to-be-administrated;
at least one collecting server;
an administrative server storing administrative information of the plurality of devices-to-be-administrated; and
a user terminal for browsing the administrative information stored in the administrative server,
wherein a communication route for transmitting the administrative information between each of the plurality of devices-to-be-administrated and the administrative server directly or via the at least one collecting server is determined in advance, and
wherein a storing portion for storing display information on a logical connection structure is provided so that the plurality of devices-to-be-administrated and/or the at least one collecting server can be displayed in a previously determined hierarchical or grouped manner regardless of the communication route when the user terminal browses the administrative information.

2. The device administrative system as recited in claim 1, wherein each of the plurality of devices-to-be-administered transmits the administrative information between the each of the plurality of devices-to-be-administered and at least one collecting server or the administrative server, and wherein the collecting server communicates the administrative information of at least one device-to-be-administered which communicates the administrative information with the collecting server among the plurality of devices-to-be-administrated between the collecting server and the administrative server.

3. The device administrative system as recited in claim 1, wherein the display information is information for specifying the lower or upper device-to-be-administered and/or the collecting server to be displayed when the user terminal browses the administrative information on each of the plurality of devices-to-be-administered and/or the at least one collecting servers.

4. The device administrative system as recited in claim 1, wherein the administrative server restricts the browsable administrative information depending on a user.

5. The device administrative system as recited in claim 1, wherein the device-to-be-administrated is an image forming device.

6. The device administrative system as recited in claim 5, wherein the administrative information is count information which is the number of times that the image forming device performed the image forming.

7. An administrative server that stores administrative information of a plurality of devices-to-be-administrated and transmits the administrative information to a user terminal, the administrative server, comprising:
a storing portion for storing display information on a logical connection structure so that a plurality of devices-to-be-administrated and/or at least one collecting server can be displayed in a previously determined hierarchical or grouped manner regardless of a communication route which communicates the administrative information directly or via the at least one collecting server between the administrative server and each of the plurality of devices-to-be-administered when a user terminal browses the administrative information; and
a transmitting portion for transmitting information for displaying the plurality of devices-to-be-administered and/or the at least one collecting server in a previously determined hierarchical or grouped manner to the user terminal based on the display information stored in the storing portion.

8. A device administrative system, comprising:
a user terminal,
a plurality of devices-to-be-administrated, and
a plurality of collecting servers that collect administrative information from at least one of the plurality of devices-to-be-administrated,
wherein one of the plurality of collecting servers functions as an administrative server, which is accessible from the user terminal, the administrative server comprises:
an administrative information storing portion for storing the administrative information of the plurality of devices-to-be-administrated collected from other colleting servers,
a display image creating portion for creating a display image in a logical connection structure showing a hierarchical relation of the collecting servers corresponding to a hierarchical organization, and
a transmitting portion for transmitting the display image created by the display image creating portion and the administrative information stored in the administrative information storing portion.

9. The device administrative system as recited in claim 8, wherein the administrative server further comprising a display information storing portion for storing display information of an upper server of each collecting server, and wherein the display image creating portion creates the display image based on the display information.

10. The device administrative system as recited in claim 8, wherein the administrative server and the plurality of collecting servers are communicated directly.

11. The device administrative system as recited in claim 8, wherein the administrative server further comprising:
a restricted information storing portion for storing browsing restriction information depending on a user regarding the administrative information, and
a browsing restriction portion for restricting a browable range of the administrative information based on the browsing restriction information.

12. The device administrative system as recited in claim 11, wherein the administrative server and the plurality of collecting servers are communicated directly.

13. An administrative server, comprising:
a communication portion which obtains administrative information from devices-to-be-administrated via a collecting server according to actual connection;
an administrative information storing portion for storing administrative information of the devices-to-be-administered obtained by the communication portion;
a display image creating portion for creating a display image on a logical connection structure showing a hierarchical relation of the collecting servers corresponding to the hierarchical organization; and
a transmitting portion for transmitting the created display information and the administrative information stored in the administrative information storing portion to a accessed user.

14. The administrative server as recited in claim 11, further comprising a display information storing portion for storing display information of an upper server of each collecting server, and wherein the display image creating portion creates the display image based on the display information.

15. The administrative server as recited in claim 11, further comprising a restricted information storing portion for storing browsing restriction information on the administrative information in accordance with a user and a browsing restriction portion for restricting the browsing range of the administrative information based on the browsing restriction information.
